(19) United States
(12) Patent Application Publication
(10) Pub. No.: US 2007/0094883 A1
(43) Pub. Date: May 3, 2007

(54) FOOTBALL DRYER

(76) Inventor: Victor Galli, Pittsburg, CA (US)

Correspondence Address: VICTOR GALLI, 4405 MIRA LOMA DR., PITTSBURG, CA, 94565, US

(21) Appl. No.: 11/263,481

(22) Filed: Nov. 1, 2005

(51) Int. Cl. F26B 25/00; F26B 25/06

(52) U.S. Cl. 34/104; 34/202; 34/236

(57) ABSTRACT

Football Dryer with a housing capable of retaining a plurality of footballs, a housing vent, a pair of drive chains, a plurality of football carrying cradles, two sets of two drive gear plates, a chain drive motor, a battery type power supply, a propane powered heater, a housing door, a door latch, a transporting handle a pair of cart wheels, and a cart wheel axle, the chain includes attachment for the football carrying cradles so that the cradles are suspended between the drive gear chains in a Ferris wheel fashion. The propane powered heater is located at the bottom of the housing so that as footballs pass by the heater they become warm and dry. A preferred embodiment includes a single football flash drying assembly that includes a ball rotator, a squeegee, and a forced hot air blower.

### CROSS REFERENCE TO RELATED APPLICATIONS

Not Applicable

### STATEMENT REGAR

Not Applicable

### DESCRIPTION OF ATTACHED APPENDIX

Not Applicable

### BACKGROUND OF THE INVENTION

This invention relates generally to the field of ball drying devices and more specifically to a football Dryer.

The game of football is well known in the United States. It is played with an elliptical shaped ball that is pointed at each end.

The ball is inflated with air and the outer skin can be made of pig skin or man made electrometric materials that are molded to simulate pig skin. The game of football is played in a variety of weather conditions including rain and snow. Under these conditions, the ball can become quite slippery and therefore more difficult to throw. Therefore it is desirable to use a dry football whenever possible. During a typical high school, or college or professional game each team uses their own footballs when they have possession of the ball. Therefore, a team that has access to a dry ball is at an advantage to a team that does not. To this end, the concept of a football dryer has been contemplated by a number of inventors.

U.S. Pat. No. 4,843,730 by C. Grant et al shows a method of drying footballs that uses silicon dioxide to absorb water. The user puts the ball in a bag with powder in it and shakes it. U.S. Pat. No. 4,055,002 by David M, Roberts et al includes a pair of contoured rollers that rotate causing a friction and rubbing to wipe the ball. U.S. Pat. No. 3,747,226 by K. Graffius shows a drier that uses electric heat lamps and needs to be plugged in to 120 volts AC. U.S. Pat. No. 4,137,040 by W. Starkey et al shows a drier that has a carrousel for the footballs to ride in and uses a generator powered by gasoline to provide power to heaters. Patent Application 2003/013602 A1 by A Pesnell shows a dryer that uses a 3000 watt heater powered by a battery. Each or the prior art sited has deficiencies that will be overcome by the present invention. The Grant patent is inherently a messy operation and rather time consuming. The Roberts patent dries only one ball at a time and is a rather complicated and expensive solution. The Graffius patent is not portable. The Starkey patent Is quite large and the use of a separate gas powered generator makes it noisy less portable than desired to be carried in a vehicle which carries football players and their equipment such as an SUV or a bus. The Pesnell patent application shows a large device that uses a 3000 watt heater powered by a battery. Even a huge battery would only last about thirty minutes putting out 3000 watts of power. Although the Ferris wheel design shown, being circular in nature, creates a lot of wasted space in the center of the circle and thereby makes the overall unit quite large thereby seriously reducing the ability for the device to be carried by normal transportation to football games that are played away from a team's home field.

In summary, the prior art does not show an ideal solution for a portable football drier that can dry a plurality of footballs quickly, can be taken to the football field without needing to be plugged in, and is small enough and light enough to be carried easily in a vehicle that is normally used for taking a football team to a game away from their home field.

### BRIEF SUMMARY OF THE INVENTION

The primary object of the invention is to provide a portable dryer for footballs for use at football games.

Another object of the invention is to provide a football dryer that dries footballs quickly for recycling into a football game.

Another object of the invention is to provide a football dryer that is compact and relatively light weight.

A further object of the invention is to provide a football dryer that uses portable power to create heat and forced air.

Yet another object of the invention is to provide a football dryer where the power can last for one football game and then be recharged or replenished.

Still yet another object of the invention is to provide a football dryer that can also be powered by 120 volts AC.

Another object of the invention is to provide a football dryer that can flash dry a single ball or slow dry a plurality of balls.

Another object of the invention is to provide a football dryer that can be rolled onto the football field.

A further object of the invention is to provide a football dryer that protects footballs from excessive heat during the drying process.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Football Dryer comprising: a housing capable of retaining a plurality of footballs, a housing vent, a pair of drive chains, a plurality of football carrying cradles, two sets of two drive gear plates, a chain drive motor, a battery type power supply, a propane powered heater, a housing door, a door latch, a transporting handle a pair of cart wheels, and a cart wheel axle, wherein said chain includes attachment means for said football carrying cradles so that said cradles are suspended between said drive gear chains in a Ferris wheel fashion, wherein said drive chains are supported by said sets of drive gear plates, wherein each set of said drive gear plates are connected by a horizontally disposed axle wherein one said axle is driven by a battery powered motor so that said drive gear plates rotate in unison causing said football cradles to travel an oblong path, Ferris wheel style, wherein said propane powered heater is located at the bottom of said housing so that as footballs sitting on said football cradles pass by said heater, they become warm and dry, wherein said footballs can enter and exit said housing through said housing door and said latch, and wherein said housing can be rolled onto a football field via a said cart wheels and said transporting handle.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a side section view of the invention.

FIG. 3 is a perspective view of a football cradle.

FIG. 4 is a front view of the invention.

FIG. 5 is a front section view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

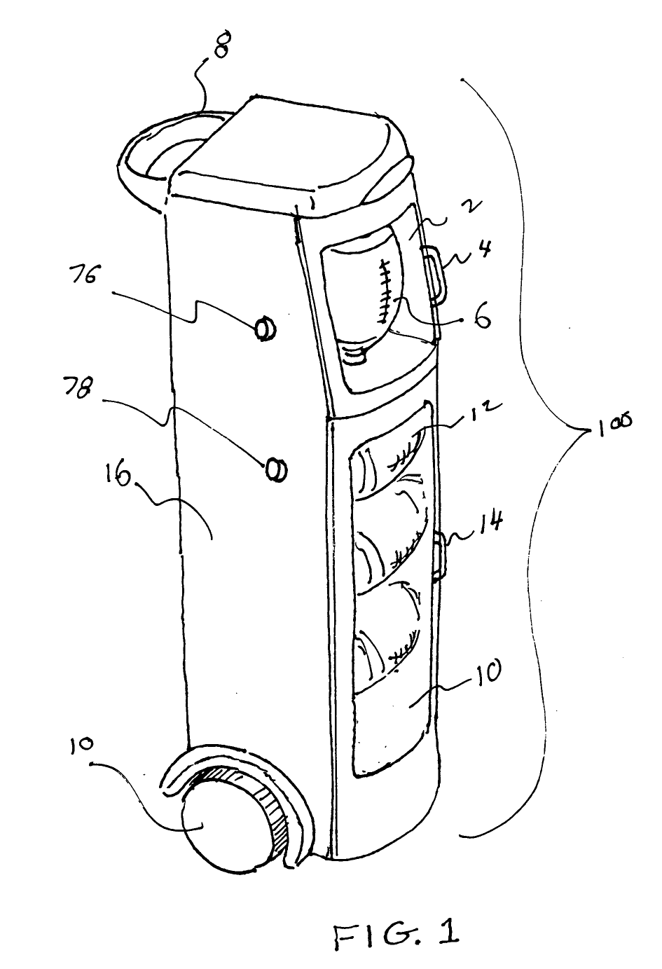

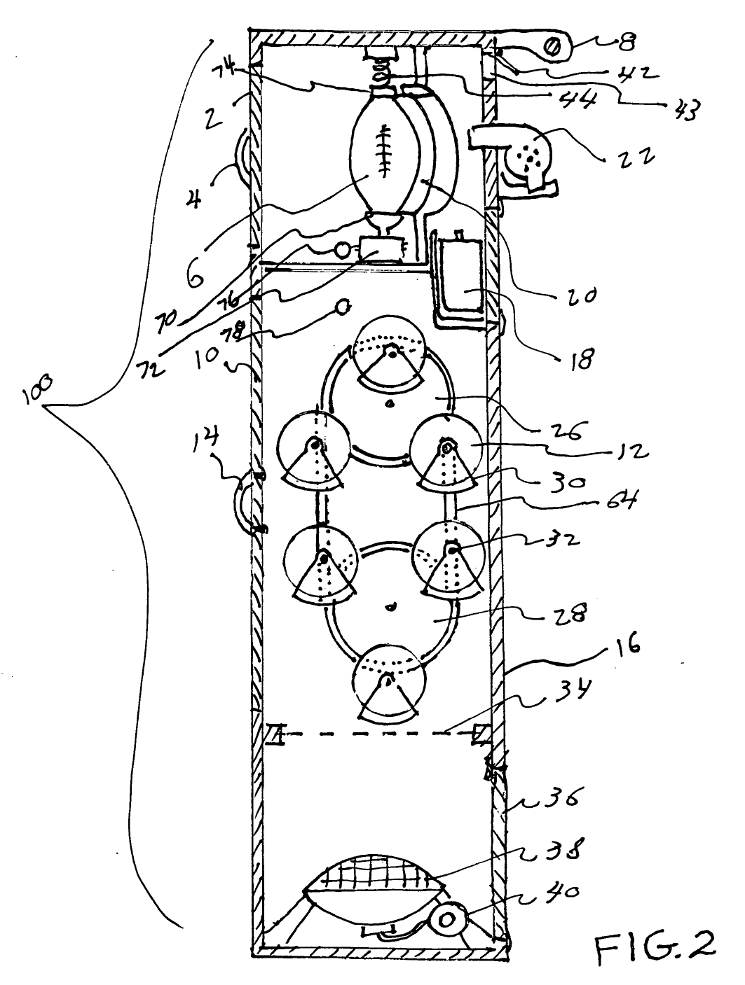

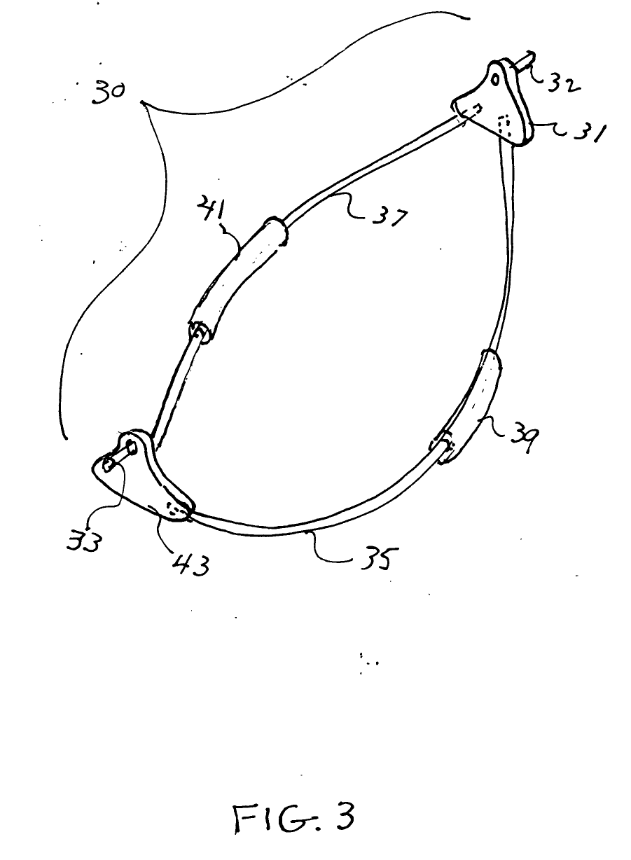

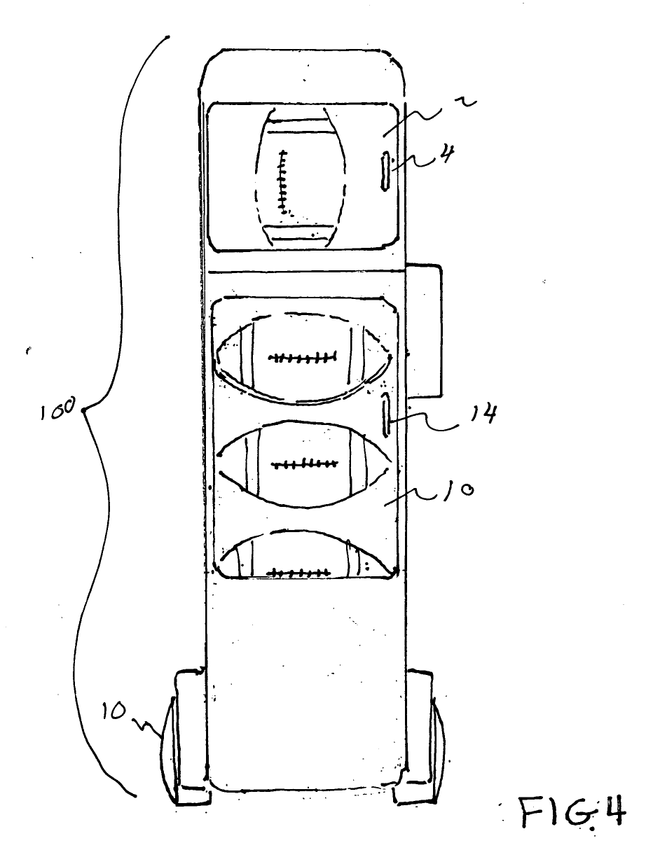

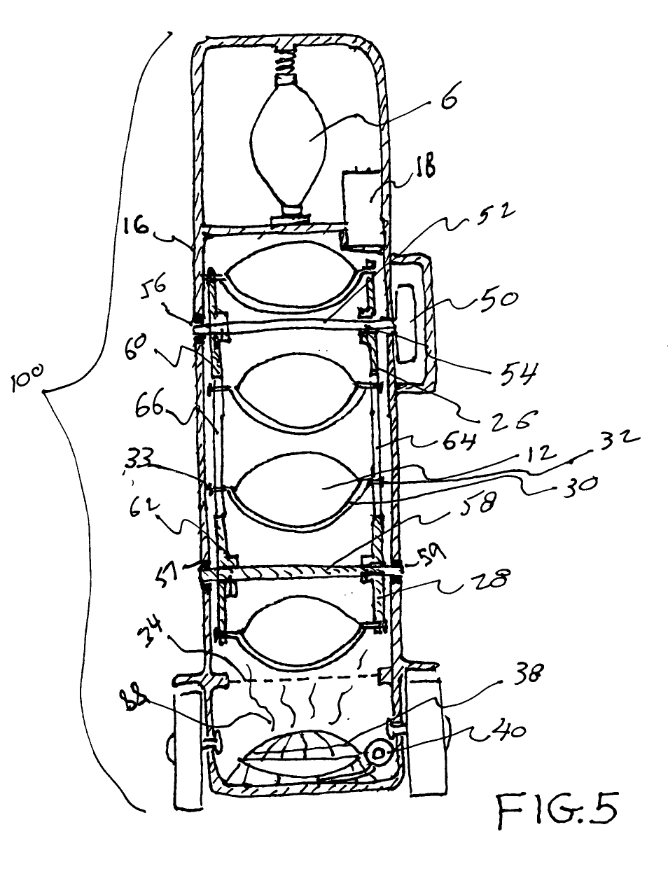

Referring now to FIG. 1 we see a perspective view of the invention 100. A housing 16 and doors 2, 10 encloses an assembly that cradles and transports footballs 12 as well as rotating a single football 6. Doors 2, 10 can be opened by pull handles 4, 14. The entire housing can be rolled by wheels 10 and pulled via handle 8. The overall dimensions of the invention 100 are approximately sixty inches tall, fourteen inches wide and twenty inches deep. I have found that this size provides the ideal balance between holding and drying enough balls to be effective during game time and yet being compact enough to be able to be easily transported in a vehicle used to carry football players to an away game such as a bus or van or SUV. FIG. 2 shows a side section view of the invention 100. There are two ball drying assemblies built into housing 16. The top assembly is a single ball flash dryer and includes a gear reduced drive motor 72, football holding cup 70 and top holding assembly 44 that includes a compression spring 44 and top holding cup 74 that allows a user to lift up on cup 74 to remove and replace ball 6. The top assembly also includes squeegee blade 20 and blow dryer 22. The blow dryer 22 and drive motor 72 are powered by battery 18. My experiments have shown that a twelve volt DC motorcycle battery 18 provides adequate power for one football game of three hours in length, after which, it can be recharged. The user starts the top assembly by turning on switch 76 causing drive motor 72 to spin and blow dryer 22 to blow hot air towards the spinning football 6. Squeegee 20 is in frictional contact with the football 6 and wipes off excess moisture and dirt. My experiments have shown that a football can be dried in approximately two minutes using this technique. The lower assembly contained within housing 16 allows a plurality of balls to be dried and warmed over a longer period of time, approximately seven minutes. My experiments have shown that six footballs can be safely contained within the housing dimensions described above. During game situations, six footballs is an adequate amount to have on hand for even long possession situations. Especially, if a ball is first dried by the top flash drying assembly before being placed in the lower Ferris wheel assembly. The lower assembly, as can be shown by FIG. 2 and FIG. 5 consists of two sets of toothed drive wheels 26, 28 and 60, 62 that support a pair of chains 64, 66. A plurality of football cradles 30 terminate in fulcrum pins 32, 33 which are in turn retained in the hollow pins of the drive chains 64, 66. The top drive wheels 26, 60 are pinned to shaft 52 which is rotated by the shaft of gear drive motor 50. Drive motor 50 is powered by battery 18. Lower drive wheels 28, 62 are pinned to shaft 58. The shafts 52, 58 are held bushings 56, 57, 59 located in the side walls of the housing 16. Therefore, when drive motor 50, powered by battery 20, is turned on by switch 78, the drive motor 50 causes the drive wheels 26, 28, 60, 62, to rotate in unison and thereby causes the cradle assemblies 30 to travel in unison along and oblong path. The oblong path is critical to the compact design of this football dryer because a minimum of space is wasted between the traveling footballs. In my experiments, the ideal speed of football travel is proximally two complete chain revolution per minute. This speed allows each football to pass in close proximity to gas heater 38 without danger of overheating. Additionally, a space of proximally one foot is needed between the face of the heater 38 and the lowest point of travel of football 12 to prevent excessive heating of the footballs. A screened portion 34 keeps footballs from accidentally falling into heat area 88 and off of the heater face. My experiments have shown that a small propane powered heater such as one made by Mr. Heater of Cleveland, Ohio that puts out eight thousand BTU's of heat at low setting and lasts over three hours per propane tank. The overall unit, powered by standard four hundred gram propane tank 40, is small and light and fits easily at the bottom of housing 16. Air vent 43 allows excess heat to exit the housing 16. Vent door 42 can be adjusted to allow more or less heated air out of the enclosed housing 16. The entire housing 16 is insulated with standard heat resistant insulation material to allow heat to be retained within the housing 16 and the outside of housing 16 is covered with a standard water resistant coating or constructed of water resistant material. FIG. 3 shows a perspective view of football cradle assembly 30. Metal rods 35, 37 are retained by end pieces 31, 43 which terminate in fulcrum pins 32, 33, the rods 35, 37 are weighted with lead weights 39, 41 to prevent the cradle from flipping upside down during its travel. FIG. 4 is affront view of the invention showing clearly doors, 2, 10, and handles 4, 14, as well as cart wheels 10.

As shown by the above description and drawings, the present invention provides a novel way to dry a plurality of footballs within a compact, portable housing that can be easily transported on a team bus or other vehicle and can be operated for the period of one football game without need to plug into a 120 volt AC outlet, or need for bulky and dangerous electrical generators or overly large gas heaters.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Football Dryer comprising:
a housing capable of retaining a plurality of footballs;
a housing vent;
a pair of drive chains;
a plurality of football carrying cradles;
two sets of two drive gear plates;
a chain drive motor;
a battery type power supply;
a propane powered heater;
a housing door;
a door latch;
a transporting handle
a pair of cart wheels; and
a cart wheel axle;
wherein said chain includes attachment means for said football carrying cradles so that said cradles are suspended between said drive gear chains in a Ferris wheel fashion;
wherein said drive chains are supported by said sets of drive gear plates;
wherein each set of said drive gear plates are connected by a horizontally disposed axle
wherein one said axle is driven by a battery powered motor so that said drive gear plates rotate in unison causing said football cradles to travel an oblong path, Ferris wheel style;
wherein said propane powered heater is located at the bottom of said housing so that as footballs sitting on said football cradles pass by said heater, they become warm and dry;
wherein said footballs can enter and exit said housing through said housing door and said latch;
and wherein said housing can be rolled onto a football field via a said cart wheels and said transporting handle.

2. Football Dryer as claimed in claim 1 further comprising a single football flash drying assembly that includes a ball rotating means;
a squeegee;
and a forced hot air blower that operates on 12 volts DC.

3. Football Dryer as claimed in claim 1 wherein said housing includes an external, hinged support pole that can support said housing in a tilted position while the user is turning on the propane heating assembly.

4. Football Dryer as claimed in claim 1 wherein said housing is insulated to prevent excessive heat from escaping said housing.

5. Football Dryer as claimed in claim 1 wherein said housing vent can be adjusted to be larger or smaller to let out more or less heat from inside said housing as needed.

6. Football Dryer as claimed in claim 1 wherein said housing is sheathed in a water resistant covering.

7. Football Dryer as claimed in claim 1 wherein the overall dimensions of said housing are small enough to allow said football dryer to be easily transported in a vehicle an SUV or school bus.
